(19) United States
(12) Patent Application Publication
(10) Pub. No.: US 2011/0280212 A1
(43) Pub. Date: Nov. 17, 2011

(54) METHOD AND SYSTEM FOR USER EQUIPMENT ACCESS, AND NETWORK ACCESS DEVICE

(75) Inventor: Yongxia LV, Beijing (CN)

(73) Assignee: Huawei Technologies Co., Ltd., Shenzhen (CN)

(21) Appl. No.: 13/195,600

(22) Filed: Aug. 1, 2011

Related U.S. Application Data
(63) Continuation of application No. PCT/CN2009/070326, filed on Feb. 1, 2009.

(51) Int. Cl. H04W 74/08

(52) U.S. Cl. 370/329

(57) ABSTRACT

An access method and a system for User Equipment (UE), and a network access device are disclosed. The access method for UE includes: sending a second Random Access Channel (RACH) message that carries Transmission Time Interval (TTI) bundling setting information to a UE after receiving a first RACH message from the UE; and receiving a third RACH message transmitted by the UE in a mode indicated by the TTI bundling setting information. With the access method and system for UE and the network access device, the second RACH message carries TTI bundling setting information so that the UE may send the third RACH message in a TTI bundling mode. Therefore, the time of random access is effectively saved. Moreover, when a UE is power-limited, the UE may send the third RACH message in a TTI bundling mode, so that the random access rate of the UE is improved.

### CROSS-REFERENCE TO RELATED APPLICATION

This application is a continuation of International Application No. PCT/CN2009/070326, filed on Feb. 1, 2009, which is hereby incorporated by reference in its entirety.

### FIELD OF THE DISCLOSURE

The present disclosure relates to the field of communication technologies, and in particular, to an access method and a system for User Equipment (UE), and a network access device.

### BACKGROUND

With the fast development of communication technologies, random access becomes an important technology for connection setup and communication between a UE and a network in a mobile communication system. The fast and efficient random access process has great significance for improving the system performance.

For a Long Term Evolution (LTE) system, a contention based random access process includes: a UE sends a first Random Access Channel (RACH) message, namely, a Physical Random Access Channel (PRACH) preamble; upon receiving the preamble correctly, an evolved NodeB (eNodeB) sends a second RACH message, namely, a RACH response. The RACH response includes a Timing Advance (TA), a Random Access Response Grant, and an allocated Cell Radio Network Temporary Identifier (C-RNTI), where the Random Access Response Grant indicates transmission information of a subsequent third RACH message; upon receiving the second RACH message correctly, the UE sends the third RACH message on a Physical Uplink Shared Channel (PUSCH) indicated by the Random Access Response Grant carried in the second RACH message; in an initial random access process, the third RACH message is a Radio Resource Configuration (RRC) Connection request, and in a started random access process after radio link fails, the third RACH message may be an RRC Connection Reestablishment request; upon receiving the third RACH message correctly, the eNodeB returns a fourth RACH message, namely, a contention resolution message, to the UE on a Physical Downlink Shared Channel (PDSCH).

The Random Access Response Grant includes the following information: 1-bit Hopping Flag, 10-bit Fixed Size Resource Block Assignment, 4-bit Truncated Modulation and Coding Scheme, 3-bit command for scheduled PUSCH (TPC), 1-bit Uplink (UL) Delay, and 1-bit Channel Quality Indication (CQI) request. In addition, according to an existing protocol, the CQI request field is reserved in a contention based random access process.

In addition, in an initial random access process or a random access process triggered by radio link failure, the eNodeB sends an RRC Connection Setup message or RRC Connection Reestablishment message, where the message includes a 1-bit Transmission Time Interval (TTI) bundling field. If TTI bundling field=ON, TTI bundling is started; if TTI bundling field=OFF, TTI bundling is not started.

In an LTE system, the minimum transmission time interval is a TTI. A UE at a cell edge may perform uplink transmission in a TTI bundling mode, that is, transmit the same piece of data in several continuous TTIs to increase the transmission gain. A group of continuous TTIs is TTI bundling, and the number of such continuous TTIs is the size of the TTI bundling. The same piece of data transmitted simultaneously is different versions of the same data, that is, data blocks with different error correction capabilities generated by encoding the same data. According to the existing LTE protocol, the size of TTI bundling is 4 TTIs, that is, 4 TTIs are used to transmit the same data four times, and a different version of the data is transmitted each time.

The inventor of the present disclosure, however, discovers some technical defects in the preceding technical solution. For example, before the UE receives an RRC Connection Setup message or RRC Connection Reestablishment message, the UE cannot obtain the configuration of TTI bundling. As a result, before the UE receives the RRC Connection Setup message or RRC Connection Reestablishment message, the uplink data to be transmitted (for example, the third RACH message) cannot support a TTI bundling mode. In this way, the time of random access cannot be effectively reduced. In addition, for those power-limited UEs at the cell edge, because of great path loss, the Signal to Noise Ratio (SNR) of the third RACH message received by the eNodeB is low, so that the third RACH cannot be successfully received. Therefore, the UE often fails to access the network.

### SUMMARY

Embodiments of the present disclosure provide an access method and a system for UE, and a network access device, which enable a UE to send a third RACH message in a TTI bundling mode, so that the time of random access is effectively saved and the random access rate of a UE is increased in a power-limited case.

An access method for a UE provided in an embodiment of the present disclosure includes: sending a second RACH message that carries TTI bundling setting information to the UE after receiving a first RACH message from the UE; and receiving a third RACH message from the UE in a mode indicated by the TTI bundling setting information.

A network access device provided in an embodiment of the present disclosure includes: a first processing module and a second module. The first module is configured to send a second RACH message that carries TTI bundling setting information to a UE after receiving a first RACH message from the UE. The second processing module is configured to receive a third RACH message transmitted by the UE in a mode indicated by the TTI bundling setting information.

An access system for UE provided in an embodiment of the present disclosure includes a network access device that communicates with a UE. The network access device is configured to receives a first RACH message from a UE and then send a second RACH message that carries TTI bundling setting information to the UE; and receive a third RACH message transmitted by the UE in a mode indicated by the TTI bundling setting information.

In the description of the access method and system for UE, and the network access device, the second RACH message carries TTI bundling setting information so that the UE can send the third RACH message in a TTI bundling mode. Therefore, the time of random access is effectively saved. Moreover, when a UE is power-limited, the UE may send the third RACH message in a TTI bundling mode, so that the random access rate of the UE is improved.

### BRIEF DESCRIPTION OF THE DRAWINGS

FIG. 1 is a flowchart showing an access method for UE according to an embodiment of the present disclosure;

FIG. 2 is a schematic diagram showing octets of a RACH response message according to an embodiment of the present disclosure;

FIG. 3 is a schematic diagram showing octets of a RACH response message that includes a new field according to an embodiment of the present disclosure;

FIG. 4 is a signaling flowchart of an access method for UE according to an embodiment of the present disclosure;

FIG. 5 is a schematic diagram showing a structure of an network access device according to an embodiment of the present disclosure; and

FIG. 6 is a schematic diagram showing a structure of an access system for network according to an embodiment of the present disclosure.

### DETAILED DESCRIPTION OF THE EMBODIMENTS

To better explain the technical solution of the present disclosure, the embodiments of the present disclosure are described in detail with reference to the accompanying drawings.

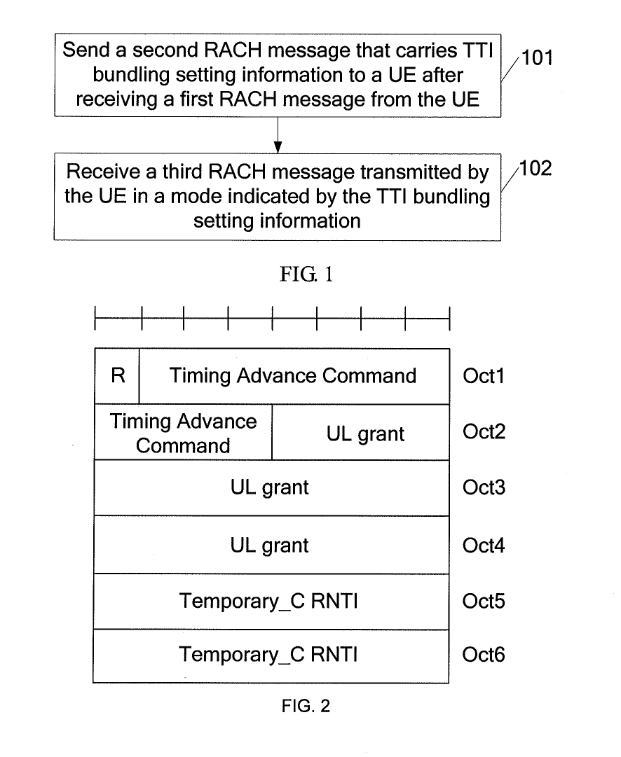

FIG. 1 is a flowchart showing an access method for UE according to an embodiment of the present disclosure. The method includes the following steps:

Step 101: A network access device sends a second RACH message that carries TTI bundling setting information to a UE after receiving a first RACH message from the UE.

After receiving a first RACH message from a UE, the network access device sends the second RACH message to the UE. The network access device may be an eNodeB or an access node. The first RACH message may be a PRACH Preamble, and the second RACH message may be an RACH response. TTI bundling setting information may be carried in the second RACH message in the following ways: configuring the TTI bundling setting information by using a reserved field in indicating information carried in the second RACH message; or configuring the TTI bundling setting information by occupying a reserved bit of the second RACH message; or configuring the TTI bundling setting information in a new field in the second RACH message.

FIG. 2 illustrates a structure of the reserved bit (R), and TTI bundling setting information may be configured through the reserved bit (R). In addition, the size of UL grant may be set to 21 bits by changing the structure of the existing RACH response, and TTI bundling setting information may be configured by using the additional 1 bit. FIG. 3 illustrates a structure of a changed RACH response, where the Random Access Response Grant includes the following information: 1-bit Hopping Flag, 10-bit Fixed Size Resource Block Assignment, 4-bit Truncated Modulation and Coding Scheme, 3-bit command for scheduled PUSCH (TPC), 1-bit UL Delay, 1-bit CQI request, and 1-bit TTI bundling. In FIG. 2 and FIG. 3, temporary C-RNTI indicates a temporary UE identifier; Timing Advance Command indicates a timing advance command; UL Grant means uplink grant; Oct means an octet that includes 8 bits; to mean octets 1-6; the UL Grant is located in 5 bits latter than Oct3, Oct4, and Oct2. Altogether, there are 8+8+5=21 bits.

Furthermore, the TTI bundling setting information includes a first setting value such as 1, and a second setting value such as 0. The first setting value 1 indicates that the TTI bundling mode is started; and the second setting value 0 indicates that the TTI bundling mode is not started. In addition, the first setting value and the second setting value may be set according to actual requirements.

Step 102: The network access device receives a third RACH message transmitted by the UE in a mode indicated by the TTI bundling setting information.

Upon receiving the TTI bundling setting information, the UE transmits a third RACH message in a mode (for example, TTI bundling mode) indicated by the preceding setting information. The network access device receives the third RACH message transmitted by the UE. The third RACH message may be an RRC Connection request or an RRC Connection Reestablishment request. The random access process is complete.

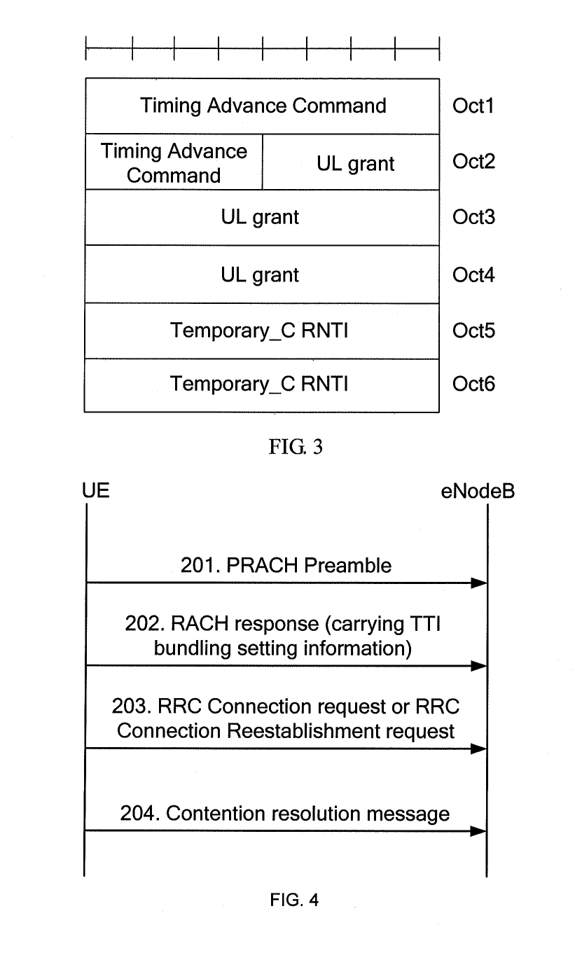

The following takes a UE and an eNodeB that works as a network access device as an example to explain the preceding random access process. FIG. 4 is a signaling flowchart of an access method for UE according to an embodiment of the present disclosure. The method includes the following steps:

Step 201: A UE sends a PRACH Preamble to an eNodeB.

This step is the same as in the prior art and will not be further described here.

Step 202: The eNodeB sends a RACH response to the UE after receiving the PRACH Preamble correctly, where the RACH response carries TTI bundling setting information.

The RACH response includes a Random Access Response Grant, where 1 bit reserved in the CQI request based on contention is used to indicate TTI bundling. That is, in a contention based random access process, if the 1 bit of the CQI request is 0, it indicates that TTI bundling is not started; if the bit 1 of the CQI request is 1, it indicates that TTI bundling is started.

Step 203: Upon receiving the RACH response correctly, the UE sends an RRC Connection request or an RRC Connection Reestablishment request to the eNodeB.

If 1 bit of the CQI request in the RACH response is 1, the UE may send a message through TTI bundling. That is, in an initial random access process, the preceding message may be an RRC Connection request; in a started random access process after radio link fails, the preceding message is an RRC Connection Reestablishment request; and the preceding message supports the Hybrid Automatic Repeat-Request (HARQ) mechanism.

Step 204: Upon receiving the RRC Connection request or RRC Connection Reestablishment request correctly, the eNodeB sends a contention resolution message to the UE.

This step is the same as in the prior art and will not be further described here.

The HARQ mechanism is used to improve the efficiency of radio link transmission. In Frequency Division Duplex (FDD) mode, there are eight parallel HARQ processes, and the transmission timeslot corresponding to a HARQ process is one TTI. The interval between two transmissions of one process, that is, a Round Trip Time (RTT), is 8 ms. In Time Division Duplex (TDD) mode, the allocation of uplink and downlink subframes in one radio frame is different. Therefore, the number of concurrent processes differs and the RTT of the same process also varies. Table 1 and Table 2 describe the different numbers of HARQ processes and different types of RTT respectively.

TABLE 1
Downlink HARQ processes and HARQ RTT lengths
under different downlink/uplink allocation

| | | | | | DL |
|---|---|---|---|---|---|
| | Average | | Maximum | Minimum | HARQ |
| DL/UL Allocation | RTT | | RTT | RTT | Processes |
| 1DL + DwPTS: 3UL | 10 | ms | 10 ms | 10 ms | 4 |
| 2DL + DwPTS: 2UL | 11.67 | ms | 13 ms | 11 ms | 7 |
| 3DL + DwPTS: 1UL | 12.5 | ms | 13 ms | 12 ms | 10 |
| 6DL + 1DwPTS: 3UL | 12.8571 | ms | 15 ms | 12 ms | 9 |
| 7DL + DwPTS: 2UL | 15 | ms | 16 ms | 14 ms | 12 |
| 8DL + DwPTS: 1UL | 16.67 | ms | 17 ms | 15 ms | 15 |
| 3DL + 2DwPTS: 5UL | 12 | ms | 14 ms | 11 ms | 6 |

TABLE 2
Uplink HARQ processes and HARQ RTT lengths
under different downlink/uplink allocation

| | | | | UL |
|---|---|---|---|---|
| | Average | Maximum | Minimum | HARQ |
| DL/UL Allocation | RTT | RTT | RTT | Processes |
| 1DL + DwPTS: 3UL | 11.67 ms | 13 ms | 11 ms | 7 |
| 2DL + DwPTS: 2UL | 10 ms | 10 ms | 10 ms | 4 |
| 3DL + DwPTS: 1UL | 10 ms | 10 ms | 10 ms | 2 |
| 6DL + 1DwPTS: 3UL | 10 ms | 10 ms | 10 ms | 3 |
| 7DL + DwPTS: 2UL | 10 ms | 10 ms | 10 ms | 2 |
| 8DL + DwPTS: 1UL | 10 ms | 10 ms | 10 ms | 1 |
| 3DL + 2DwPTS: 5UL | 12 ms | 14 ms | 11 ms | 6 |

From the preceding tables, it is obvious that the RTT of two transmissions of either FDD or TDD is at least 8 ms. The protocol prescribes that compared with the HARQ, the interval between two transmissions should be 1 ms in a TTI bundling mode. Therefore, transmitting the third RACH message in a TTI bundling mode may greatly save the time of random access.

In addition, according to the existing LTE protocol, the size of TTI bundling is 4 TTIs, that is, 4 TTIs are used to transmit the same data four times, and a different version of the data is transmitted each time. For those UEs at the cell edge, although the power is limited and the path loss is great, the transmission of the third RACH message in a TTI bundling mode is similar to four repetitions, providing four times the transmit power. In this way, the SNR at the receiving end is effectively increased. So that the rate of successful reception of the third RACH message is improved and the random access rate of the UE is promoted.

With the preceding access method for UE, the second RACH message carries TTI bundling setting information, so that the UE may send the third RACH message in a TTI bundling mode. Therefore, the time of random access is effectively saved. Moreover, when a UE is power-limited, the UE may send the third RACH message in a TTI bundling mode, so that the random access rate of the UE is improved.

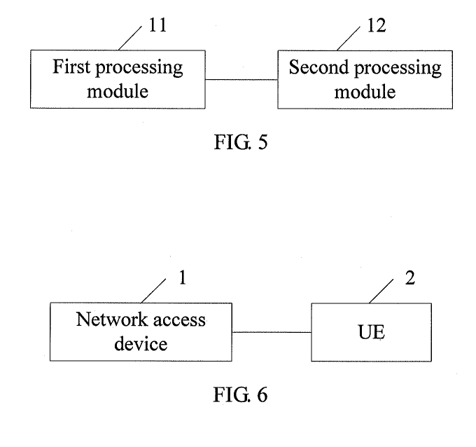

FIG. 5 is schematic diagram showing a structure of a network access device provided according to an embodiment of the present disclosure. The network access device includes: a first processing module 11, configured to send a second RACH message to a UE after receiving a first RACH message from the UE, where the second RACH message carries TTI bundling setting information; and a second processing module 12, configured to receive a third RACH message transmitted by the UE in a mode indicated by the TTI bundling setting information.

To access the network efficiently and fast, the first processing module may include: a first configuring unit, adapted to configure TTI bundling setting information by using a reserved field in indicating information carried in the second RACH message; or a second configuring unit, adapted to configure TTI bundling setting information by occupying a reserved bit of the second RACH message; or a third configuring unit, adapted to configure TTI bundling setting information in a new field of the second RACH message. According to the TTI bundling setting information configured by the first configuring unit, second configuring unit, or third configuring unit, the UE may transmit a third RACH message in a TTI bundling mode. Furthermore, for a UE with limited power, transmitting a third RACH message in a TTI bundling mode may greatly increase the access rate of the UE.

In addition, the network access device may be a home NodeB or an access node.

With the preceding network access device, the first processing module sends the second RACH message that carries TTI bundling setting information to the UE, so that the UE can send the third RACH message in a TTI bundling mode. Therefore, the time of random access is saved. In addition, when the UE is power-limited, sending the third RACH message in a TTI bundling mode increases the random access rate of the UE.

FIG. 6 is a schematic diagram showing a structure of an access system for UE according to an embodiment of the present disclosure. The system includes a network access device 1 and a UE 2. The network access device 1 is configured to send a second RACH message that carries TTI bundling setting information to the UE 2 after receiving a first RACH message from the UE 2; and configured to receive a third RACH message transmitted by the UE 2 in a mode indicated by the TTI bundling setting information.

The network access device may include a configuring module, adapted to configure TTI bundling setting information by using a reserved field in indicating information in the second RACH message; or adapted to configure TTI bundling setting information by occupying a reserved bit of the second RACH message; or adapted to configure TTI bundling setting information in a new field of the second RACH message. According to the TTI bundling setting information configured by the configuring module, the UE may send a third RACH message in a TTI bundling mode. Furthermore, for a UE with limited power, transmitting a third RACH message in a TTI bundling mode greatly increases the access rate of the UE.

In addition, the network access device may be a home NodeB or an access node.

In the access system for UE, through the interaction between the network access device and the UE, the second RACH message carries TTI bundling setting information so that the UE may send the third RACH message in a TTI bundling mode. Therefore, the time of random access is effectively saved. Moreover, when a UE is power-limited, the UE may send the third RACH message in a TTI bundling mode, so that the random access rate of the UE is improved.

Although the present disclosure is described in detail through some exemplary embodiments, the disclosure is not limited to such embodiments. It is apparent that those skilled in the art may make various modifications or equivalent replacements to the disclosure without departing from the spirit and scope of the present disclosure.

What is claimed is:

1. An access method for a User Equipment (UE), comprising:
sending a second Random Access Channel (RACH) message that carries Transmission Time Interval (TTI) bundling setting information to the UE after receiving a first RACH message from the UE; and
receiving a third RACH message from the UE in a mode indicated by the TTI bundling setting information.

2. The method of claim 1, wherein the second RACH message carrying the TTI bundling setting information comprises one of the following:
configuring the TTI bundling setting information by using a reserved field in indicating information in the second RACH message;
configuring the TTI bundling setting information by occupying a reserved bit of the second RACH message; and
configuring the TTI bundling setting information in a new field of the second RACH message.

3. The method of claim 2, wherein the reserved field is a reserved field of a Channel Quality Indication (CQI) request.

4. A network access device, comprising:
a first processing module, configured to receive a first Random Access Channel (RACH) message from a User Equipment (UE) and then send a second RACH message that carries Transmission Time Interval (TTI) bundling setting information to the UE; and
a second processing module, configured to receive a third RACH message transmitted by the UE in a mode indicated by the TTI bundling setting information.

5. The network access device of claim 4, wherein the first processing module comprises one of the following:
a first configuring unit, adapted to configure the TTI bundling setting information by using a reserved field in indicating information in the second RACH message;
a second configuring unit, adapted to configure the TTI bundling setting information by occupying a reserved bit of the second RACH message; and
a third configuring unit, adapted to configure the ITT bundling setting information in a new field of the second RACH message.

6. The network access device of claim 5, wherein the reserved field is a reserved field of a Channel Quality Indication (CQI) request.

7. The network access device of claim 4, wherein the network access device is a home NodeB or an access node.

8. An access system for User Equipment (UE), comprising a network access device configured to communicate with a UE, wherein:
the network access device is configured to send a second Random Access Channel (RACH) message that carries Transmission Time Interval (TTI) bundling setting information to the UE after receiving a first RACH message from the UE, and receive a third RACH message transmitted by the UE in a mode indicated by the TTI bundling setting information.

9. The system of claim 8, wherein the network access device comprises:
a configuring module, adapted to configure the TTI bundling setting information by using a reserved field in indicating information in the second RACH message; or adapted to configure the TTI bundling setting information by occupying a reserved bit of the second RACH message; or adapted to configure the TTI bundling setting information in a new field of the second RACH message.

10. The system of claim 8, wherein the network access device is a home NodeB or an access node.
